(19) United States
(12) Patent Application Publication
(10) Pub. No.: US 2007/0016832 A1
(43) Pub. Date: Jan. 18, 2007

(54) System, device and method of verifying that a code is executed by a processor

(76) Inventor: Yoav Weiss, Petach Tikva (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/480,505

(22) Filed: Jul. 5, 2006

Related U.S. Application Data
(60) Provisional application No. 60/748,165, filed on Dec. 8, 2005.

(30) Foreign Application Priority Data
Jul. 4, 2005 (IL) 169523

(51) Int. Cl. G06F 11/00

(52) U.S. Cl. 714/100

(57) ABSTRACT

Some demonstrative embodiments of the invention include a method, device and/or system of verifying that a secure code is executed by a processor. The device may include, for example, a memory to store a secure code; a processor intended to execute a gating code, wherein the gating code, when executed by the processor, results in the processor to perform at least one operation and set a program counter of the processor to point to an entry point of the secure code; and a verifier to verify that the processor had executed the gating code only if the processor performs the at least one operation. Other embodiments are described and claimed.

### CROSS REFERENCE TO RELATED APPLICATIONS

This application claims priority of Israel Patent Application 169523, filed Jul. 4, 2005, and U.S. Provisional Application No. 60/748,165, filed Dec. 8, 2005, the entire disclosure of both of applications are incorporated herein by reference.

### BACKGROUND OF THE INVENTION

A conventional Operating System (OS) environment may have two modes of operation, namely a User Mode and a Kernel Mode. The User Mode may be implemented to run user-applications and may have restricted access to one or more system components, e.g., a memory. The Kernel Mode may have direct access to one or more components not accessed by the User Mode, e.g., the memory. User-mode code may only interact with system components via interfaces provided by the kernel.

In some high-security situations, even the kernel itself cannot be trusted with some secrets, and a secure mode of operation may be implemented to hide and/or protect certain data or operations from any code running on the system, including kernel code. The secure mode may be implemented by dedicated secure-mode hardware components, e.g., the ARM TrustZone®. The secure-mode hardware may include a memory, which may only be accessible to a processor while in the secure mode; and a mechanism to ensure that the processor never executes untrusted code while in the secure mode.

An attacker may attempt, for example, to access the secure memory using untrusted code, e.g., if the processor is allowed to execute untrusted code while operating in the secure mode. The secure mode hardware may include an instruction, which may start an atomic context switch that results in executing a handler that resides in the secure memory. However, implementation of the secure-memory hardware may require modification of the processor.

### SUMMARY OF SOME DEMONSTRATIVE EMBODIMENTS OF THE INVENTION

Some demonstrative embodiments of the invention include a method, device and/or system of verifying that a secure code is executed by a processor.

According to some demonstrative embodiments of the invention, the device may include a memory to store a secure code; a processor intended to execute a gating code, wherein the gating code, when executed by the processor, results in the processor to perform at least one operation and set a program counter of the processor to point to an entry point of the secure code; and a verifier to verify that the processor had executed the gating code only if the processor performs the at least one operation.

According to some demonstrative embodiments of the invention, the verifier may generate a violation output if the processor does not perform the at least one operation during at least one predefined time period.

According to some demonstrative embodiments of the invention, the verifier may maintain at least one secret value. The gating code, when executed by the processor, may results in the processor writing the at least one secret value to the verifier. The verifier may generate the violation output if the secret value is not written to the verifier during the predefined time period.

According to some demonstrative embodiments of the invention, the predefined time period may include a time period shorter than a time period required for the processor to perform a read operation followed by a write operation.

According to some demonstrative embodiments of the invention, the at least one secret value may include a sequence of secret values. The gating code, when executed by the processor may result in the processor writing the sequence of values to the verifier. The at least one predefined time period may include a sequence of predefined time periods during which the secret values are to be written to the verifier, respectively. The verifier may generate a violation output when a secret value of the sequence of secret values is not written to the verifier during a respective time period of the sequence of time periods.

According to some demonstrative embodiments of the invention, the verifier may maintain at least one address value representing at least one respective memory address. The gating code, when executed by the processor, may result in the processor accessing the at least one memory address. The verifier may generate the violation output if the address is not accessed during the time period.

According to some demonstrative embodiments of the invention, the time period may include a time period substantially equal to a time period required for the processor to execute a load operation.

According to some demonstrative embodiments of the invention, the at least one address value may include a sequence of address values representing a sequence of memory addresses, respectively. The gating code, when executed by the processor, may result in the processor accessing the sequence of addresses. The at least one predefined time period may include a sequence of predefined time periods, during which the sequence of addresses are to be accessed, respectively. The verifier may generate the violation output when an address of the sequence of addresses is not accesses during a respective time period of the sequence of time periods.

According to some demonstrative embodiments of the invention, the gating code may include a sequence of branch commands stored in a sequence of addresses, respectively. The sequence of branch commands, when executed by the processor, may result in the processor sequentially branching between the addresses.

According to some demonstrative embodiments of the invention, the at least one predefined time period may include a sequence of predefined time periods, during which the processor is to sequentially branch between the sequence of addresses, respectively. The verifier may generate the violation output when an address of the sequence of addresses is not accessed during a respective time period of the sequence of time periods.

According to some demonstrative embodiments of the invention, the gating code may include a sequence of conditional branch commands. Each conditional branch command, when executed by the processor, may result in the processor evaluating a condition relating to one or more values derived from a secret value and in selectively executing the branch command based on the condition. The at least one predefined time period may include, for example, a sequence of predefined time periods, during which the processor is to perform a respective sequence of branching operations resulting from the conditional branch commands. The verifier may generate the violation output when a branching operation of the sequence of branching operations is not performed during a respective time period of the sequence of time periods.

According to some demonstrative embodiments of the invention, each of the sequence of time periods may include a time period substantially equal to a time period required for the processor to execute an evaluation operation followed by a conditional branching operation.

According to some demonstrative embodiments of the invention, the violation output may cause the processor to reset.

According to some demonstrative embodiments of the invention, the device may include a memory watcher to identify an attempt to access the secure code and, upon the attempt, to cause the verifier to verify whether the processor executes the gating code.

According to some demonstrative embodiments of the invention, the verifier may provide the memory watcher with a verification signal verifying that the processor executes the gating code.

According to some demonstrative embodiments of the invention, the memory watcher may selectively allow direct-memory-access to the secure code based on the verification signal.

According to some demonstrative embodiments of the invention, the memory watcher may compare an address-bus output of a controller of an address bus connecting the memory to the processor to an address-bus input of the memory, and generate a security violation output if the address-bus output does not match the address-bus input.

According to some demonstrative embodiments of the invention, the memory watcher may disable access to the memory when the processor does not control a bus connecting the processor and the memory.

According to some demonstrative embodiments of the invention, the gating code may be stored in the memory.

According to some demonstrative embodiments of the invention, the verifier may generate the gating code based on a secret value.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a computing system including a verifier according to some demonstrative embodiments of the invention; and

FIG. 2 is a flowchart illustration of a method of verifying that a processor executes a code according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art. An algorithm is here, and generally, considered to be a self-consistent sequence of acts or operations leading to a desired result These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Embodiments of the present invention may include apparatuses for performing the operations herein. These apparatuses may be specially constructed for the desired purposes, or they may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, a Dynamic RAM (DRAM), a Synchronous DRAM (SD-RAM), a Flash memory, a volatile memory, a non-volatile memory, a cache memory, a buffer, a short term memory unit, a long term memory unit, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. Although the invention is not limited in this respect, some demonstrative embodiments of the invention may be implemented using any suitable embedded system.

Part of the discussion herein may relate, for demonstrative purposes, to executing and/or accessing a code. However, embodiments of the invention are not limited in this regard, and may include, for example, executing and/or accessing one or more instructions, one or more commands, or the like.

The phrase “secure mode” as used herein may refer to an environment, mode of operation, and/or operating condition, to prevent unauthorized, uncertified and/or unapproved access, e.g., partial or complete physical and/or electronic access, to one or more processes, instructions and/or operations executed, and/or performed in secure mode; and/or to data, code, and/or any other information managed, stored, and/or maintained in a secure memory. The secure mode may be implemented using any suitable arrangement, configuration, and/or combination of hardware and/or software. For example the secure mode may be implemented by an operating system and/or secure hardware, alone or in combination. Accordingly, a non-secure mode may refer to any environment, mode of operation, and/or operating condition, different than the secure mode, e.g., wherein unauthorized, uncertified and/or unapproved access is not prevented. The secure mode and non-secure mode may be implemented using separate and/or common arrangements, configurations, and/or combinations of resources, hardware and/or software.

The phrase “trusted code” as used herein may refer to code, which may be determined, assumed, presumed, and/or recognized to be authorized code certified code, approved code, and/or code that may not harm, destroy, and/or attack any component of a computing system. Accordingly, the phrase “untrusted code” as used herein may refer to code, which is not determined, assumed, presumed, and/or recognized to be authorized code, certified code, approved code, and/or code that may not harm, destroy, and/or attack any component of the computing system.

According to some demonstrative embodiments of the invention, it may be desirable to ensure that a processor branches to an entry-point of a trusted code in a secure memory, following, e.g., substantially immediately, an enabling access to the secure memory, for example, in order to prevent an attacker from accessing the secure memory with untrusted code. Accordingly, it may be desired to ensure that an operation “enable-secure-memory+brach-to-secure-code” is performed as an atomic operation. In one example, a secure-mode hardware component may be implemented to generate a hardware-interrupt resulting in the processor branching to the entry-point, e.g., following a request from the processor to enter secure mode. However, code running on the processor, e.g., during a Kernel Mode, may mask the interrupt, or may replace an interrupt-vector to point to untrusted code instead of the entry-point. The secure-mode hardware may not be able to verify that the processor actually branches to the entry-point. In addition, external signals generated by the trusted code may be generated by a cloned version of the trusted code, e.g., running from insecure memory.

Some demonstrative embodiments of the invention may include a method, device and/or system to verify and/or indicate that a processor executes a gating code based on one or more operations performed by the processor. The gating code may include, for example, code that when executed by the processor results in the processor performing at least one operation (“the gating operation”) followed by setting a Program Counter (PC) to point to an entry point of secure code to be executed by the processor. A verifier may verify that the processor executes the gating code, e.g. only if the processor performs the gating operation. The gating operation may include an operation identifiable externally to the processor. Although the invention is not limited in this respect, the gating operation may result in a “side-effect”, which may be identifiable externally to the processor, e.g., a bus event as described below.

The devices, systems and/or methods according to some demonstrative embodiments of the invention may enable verifying, for example, that the processor does not execute any untrusted code between enabling access to the secure memory and branching to the secure code. For example, the verifier may verify that enabling access to the secure memory and branching to the secure code are performed as an atomic operation. Although the invention is not limited in this respect, in some demonstrative embodiments the verifier may also indicate that the execution of the gating code has been verified, e.g., as described below.

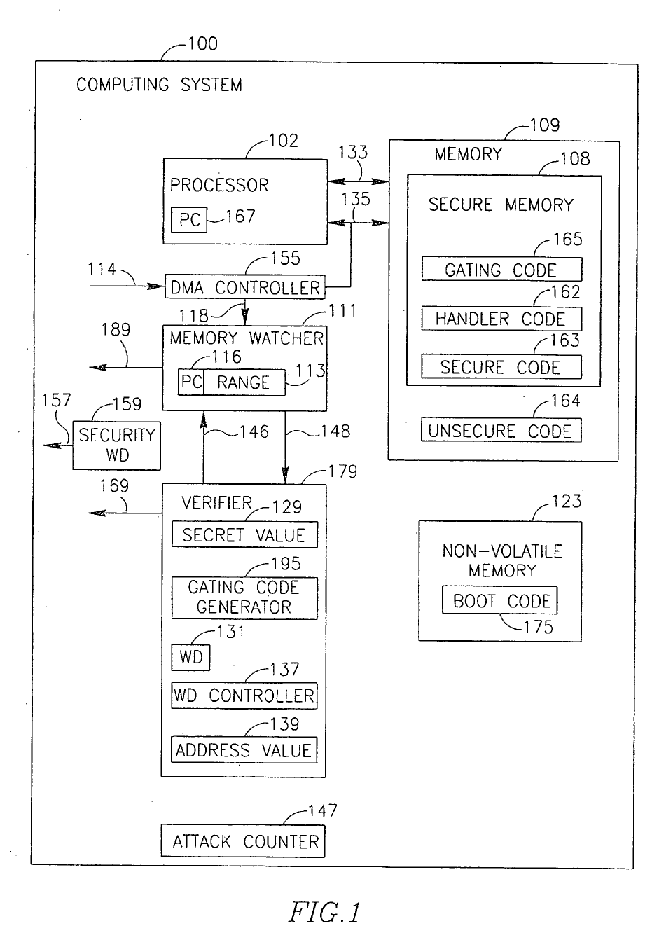

Reference is made to FIG. 1, which schematically illustrates a computing system 100 according to some demonstrative embodiments of the invention.

According to some demonstrative embodiments of the invention, system 100 may include or may be a portable device. Non-limiting examples of such portable devices include mobile telephones, cellular handsets, laptop and notebook computers, personal digital assistants (PDA), and the like. For example, computing system 100 may include or may be cellular handset. Alternatively, computing system 100 may be a non-portable device, e.g., a personal computer, a server computer, or the like.

According to some demonstrative embodiments of the invention, system 100 may include a processor 102, a secure memory 108, a verifier 179, and/or a memory watcher 111, e.g., as are described in detail below.

Processor 102 may include, for example, a Central Processing Unit (CPU), a Digital Signal Processor (DSP), a microprocessor, a host processor, a plurality of processors, a controller, a microcontroller, a chip, a microchip, or any other suitable multi-purpose or specific processor or controller. Memory 108 may include, for example, a volatile memory, e.g., a RAM, a DRAM, a SD-RAM, or the like.

According to some demonstrative embodiments of the invention, system 100 may have a secure mode of operation and a non-secure mode of operation. The secure mode and/or non-secure mode may be implemented using any suitable arrangement, configuration, and/or combination of hardware and/or software.

Although the invention is not limited in this respect, according to some demonstrative embodiments of the invention, system 100 may maintain a boot code 175 to be executed by processor 102 during a Boot process of computing system 100, e.g., as described in detail below. Boot code 175 may be maintained, for example, by a non-writable memory 123, e.g., a ROM.

According to some demonstrative embodiments of the invention, secure memory 108 may maintain secure code 163, e.g. including trusted code intended to be executed by processor 102 in the secure mode.

According to some demonstrative embodiments of the invention, verifier 179 may selectively provide memory watcher with a signal 146 indicating that processor 102 is verified to be operating in the secure mode, e.g., as described in detail below.

According to one demonstrative embodiment of the invention, secure memory 108 may be implemented as a dedicated secure memory module, e.g., separate from a non-secure memory module maintaining unsecure code. Memory watcher 111 may be connected to memory 108, e.g., such that memory 108 may be accessed only via memory watcher 111. For example, any attempt to access memory 108, e.g., including an access attempt by processor 102 and/or an external Direct-Memory-Access (DMA) transfer, may be controlled by memory watcher 111. Memory watcher 111 may allow access to memory 108, for example, only when system 100 is in the secure mode. For example, memory watcher 111 may allow access to memory 108 only if memory watcher 111 receives signal 146 and/or any other signal indicating system 100 is operating in the secure mode.

According to other demonstrative embodiments of the invention, memory 108 may be implemented as part of a memory module 109, which may also maintain non-secure code 164, e.g., including code which may be accessed when system 100 is in the non-secure mode. Memory watcher 111 may maintain a range indicator 113 to indicate at least one range of addresses of memory 109 (“secure address range”) to be accessed in the secure mode. Memory watcher 111 may allow updating the secure address ranges indicated by indicator 113, e.g., to add or delete one or more secure addresses, for example, only when system 100 is operating in the secure mode. For example, memory watcher 111 may allow updating the secure address range indicated by indication 113 only when memory watcher receives signal 146 and/or any other suitable indication that system 100 is operating in the secure mode. In some demonstrative embodiments of the invention, the at least one secure address range may include a plurality of address ranges corresponding to a plurality of secure modes, e.g., as described below.

According to one demonstrative embodiments of the invention, memory watcher 111 may be connected to memory 109, e.g., such that memory 109 may be accessed only via memory watcher 111. For example, any attempt to access secure memory 109, e.g., including an access attempt by processor 102 and/or an external DMA transfer, may be controlled by memory watcher 111. According to this embodiment, memory watcher 111 may receive a request, e.g., from processor 102 or any other component of system 100, to access an address of memory 109 (“the requested address”). Memory watcher 111 may selectively allow access to the requested address based, for example, on the secure address range and/or the mode of operation of system 100. If, for example, the requested address is within the secure address range, then memory watcher 111 may allow access to the requested address only when system 100 is operating in the secure mode. For example, if the requested address is within the secure address range, then memory watcher 111 may allow access to the requested address only when memory watcher 111 receives signal 146 and/or any other suitable indication that system 100 is operating in the secure mode. Although the invention is not limited in this respect, if the requested address is within the secure address range and system 100 is operating in the non-secure mode, then memory watcher 111 may generate a security-violation output 189. Security violation output 189 may cause processor 102 to generate an “illegal-memory-access” interrupt; cause a reset of processor 102, and/or any other suitable operation.

Memory watcher 111 may also generate a signal 148 indicating that an attempt has been made to access secure memory 108 if, for example, the requested address is within the secure address range. Although the invention is not limited in this request, if the requested address corresponds to an address of a gating code 165, then memory watcher 111 may allow access to gating code 165 and generate signal 148 to cause verifier 179 to verify that processor 102 executes gating code 165, e.g., as described in detail below.

According to another demonstrative embodiment of the invention, memory 109 may be accessed, e.g., by processor 102 and/or any other component of system 100, independently of memory manager 111. For example, memory 109 may be accessed over a bus, e.g., including data bus 133 and/or an address bus 135, which may connect between memory 109 and processor 102. Memory watcher 111 may be connected in parallel to memory 109, e.g., if bus 135 includes a bus having hierarchies. According to this embodiment, memory watcher 111 may be connected, for example, to address bus 135. Memory watcher 111 may monitor attempts to access memory 109, and may selectively generate signal 148, e.g., based on a comparison of the requested address to the secure address range. For example, memory watcher 111 may generate signal 148 if the requested address is within the secure address range. Memory watcher 111 may not generate signal 148 if, for example, the requested address is not within the secure address range. In one non-limiting example, if the requested address is within the secure address range and system 100 is operating in the none-secure mode, then memory watcher 11 may generate security-violation output 189, e.g., as described above. Although the invention is not limited in this request, if the requested address corresponds to an address of gating code 165, then memory watcher 111 may allow access to gating code 165, and may generate signal 148 to cause verifier 179 to verify that processor 102 executes gating code 165, e.g., as described in detail below.

Although the invention is not limited in this respect, according to some demonstrative embodiments of the invention, memory watcher 111 may provide verifier with signal 148, e.g., only when memory watcher 111 does not receive signal 146. For example, memory watcher 111 may disable signal 148, e.g., as long as memory watcher 111 receives signal 146. This may result in memory watcher 111 activating verifier 179, to verify processor 102 executes gating code 165, only when memory watcher 111 does not receive signal 146.

According to some demonstrative embodiments of the invention, it may be desired to verify that processor 102 does not execute any untrusted code, e.g., after enabling the secure mode and/or before executing secure code 163, e.g., as described below.

According to some demonstrative embodiments of the invention, processor 102 may be able to execute gating code 165, which may be maintained in secure memory 108; and/or generated by verifier 179, as described in detail below. Gating code 165, when executed by processor 102 may result in processor 102 performing at least one gating operation prior to setting a PC 167 of processor 102 to point to an entry-point of secure code 163, as described in detail below.

According to some demonstrative embodiments of the invention, verifier 179 may verify that processor 102 executes gating code 165 only if, for example, processor 102 performs the at least one gating operation. For example, the at least one gating operation may include a bus event, e.g., processor 102 may perform at least one operation over data bus 133; and/or an operation over address bus 135, as described below. However, it will be appreciated by those of ordinary skill in the art that the gating operation may include any suitable operation which may be, for example, identifiable externally to processor 102. The gating operation may include, for example, a measurable attribute or parameter which may be affected by the operation of processor 102. For example, the gating operation may include a power and/or current consumption of processor 102, a temperature of processor 102 and the like.

According to some demonstrative embodiments of the invention, verifier 179 may generate a verification violation output 169, for example, if verifier 179 does not verify that processor 102 performs gating code 165, e.g., within at least one predefined time period, e.g., as described in detail below. Although the invention is not limited in this respect, violation output 169 may include any suitable signal, e.g., as is known in the art, to cause processor 102 to perform a reset operation and/or any other suitable operation.

According to some demonstrative embodiments of the invention, verifier 179 may be able to measure the at least one predefined time period, e.g., following an attempt to access secure memory 108, e.g., as described below. For example, verifier 179 may begin measuring the at least one predefined time period upon receiving signal 148, which may indicate an attempt to access an address within the secure address range.

Although the invention is not limited in this respect, verifier 179 may include a watchdog (WD) 131, which may be activated to countdown the predefined time period, e.g., independently of the operation of processor 102. WD 131 may generate violation output 169, e.g., if WD completes measuring the predefined time period. WD 131 may be de-activated to stop counting down, e.g., only if WD 131 receives a WD-off command.

According to some demonstrative embodiments of the invention, verifier 179 may also include a WD controller 137 to selectively provide the WD-off command to WD 131 based on whether processor 102 performs the one or more gating operations.

According to one demonstrative embodiment of the invention, verifier 179 may maintain at least one secret value 129, and WD controller 137 may provide the WD-off command to WD 131 e.g., only if processor 102 writes the secret value to verifier 179 over data bus 133, e.g., as described in detail below. According to this embodiment, gating code 165 when executed by processor 102 may result in processor 102 writing the at least one secret value to verifier 179. For example, gating code may include an immediate/direct write command including the secret value.

The secret value may be generated, e.g., during a Boot sequence of system 100. For example, processor 102 may execute boot code 175, e.g., during the Boot sequence. Boot code 175, when executed by processor 102, may result, for example, in generating the secret value. The secret value may be generated, for example, using a Random Number Generator (RNG), e.g., as is known in the art. Boot code 175 may also result in storing the secret value in verifier 179, and/or including in gating code 165, e.g., at the beginning of gating code 165, a direct write instruction to write the secret value to verifier 179.

According to another demonstrative embodiment of the invention, verifier 129 may maintain at least one address value 139, and WD controller 137 may provide the WD-off command to WD 131, e.g., only if processor 102 accesses, e.g., over address bus 135, an address of memory 108 corresponding to address value 139, e.g., as described in detail below. For example, WD controller 137 may provide the WD-off command if memory offset corresponding to the address value is accessed. This embodiment may be implemented if, for example, an immediate-write instruction does not exist, or is not faster than a register-based “Read+Write” sequence of operations.

According to this embodiment, gating code 165 when executed by processor 102 may result in processor 102 accessing at least one address corresponding to at least one address value 139. For example, gating code 165 may include at least one load command.

The secret address value may be generated, e.g., during the Boot sequence of system 100. For example, boot code 175, when executed by processor 102, may result, for example, in generating the secret address value, e.g., as described above. Boot code 175 may also result in storing the secret address value in verifier 179, and/or including in gating code 165, e.g., at the beginning of gating code 165, a load instruction to access an address corresponding to the secret address value.

According to yet another embodiment of the invention, the secret address value may relate to a limited address offset, e.g., a 12 bit offset. It may be desired to increase the entropy of the secret address value. Gating code 165 may result in a sequence of memory accesses, e.g., to a sequence of addresses. For example, WD controller 137 may sequentially reset WD 131 to countdown, e.g., following every access to an address in the sequence of addresses. Although the invention is not limited in this respect, boot code 175 may result in generating N random words, e.g., of an offset size. Boot code 175 may also result in writing the N words to N address registers of verifier 179 (not shown). Boot code 175 may also result in writing N read instructions to gating code 165, each to result in processor 102 reading from a respective one of the N random words. When executed by processor 102, gating code 165 may result in processor 102 sequentially accessing the N words. Verifier 179 may reset WD 131, e.g., every time processor 102 accesses a word corresponding to a respective one of the N words.

According to yet another embodiment of the invention, gating code 165 may result in processor branching between a sequence of specific addresses, e.g., in a manner which may be hard to imitate without prior knowledge of the sequence. The sequence of addresses may be encoded, for example, as a permutation over an access-order, e.g., instead of an address offset of a single access. Accordingly, gating code 165 when executed by processor 102 may result in processor branching between the sequence of addresses by performing identifiable Fetch operations over bus 135. A minimal distance between addresses in the sequence may be for example, a size of a cache-word, such that the Fetches operations may be identified over bus 135. However, the minimal distance may be related to any other factors.

According to this embodiment, verifier 179 may act as a multi-level verifier, expecting a sequence of address offsets, e.g., rather than a single address offset. WD controller 137 may control WD 131 to perform a sequence of countdown operations to measure a sequence of time periods during which processor 102 is expected to access a respective sequence of specific address. WD controller 137 may reset WD 131, e.g., every time processor 102 accesses the specific address.

According to this embodiment boot code 175, when executed by processor 102, may result, for example, in generating a table of branch instructions, with offsets ordered, e.g., based on the secret value as described above. Boot code 175 may also result in storing a table of addresses resulting from the branch instructions in verifier 179, and/or including in gating code 165, e.g., at the beginning of gating code 165, the table of branch instructions.

It will be appreciated that a cached attack-code may be faster than uncached gating code, e.g., by orders of magnitude. For example, a sequence of “UncachedFetch+Execute+Read”, which may be used by the gating code, may take as long as a Read+CachedFetch+Execute+Read used by an attacker. This may enable an attacker to steal the gating code and use its content to emulate a legitimate entry and turn WD 131 off before it expires if, for example:

time(Read+CachedFetch)<=time(UncachedFetch))

or:

time(CachedFetch+Execute+Read+CachedFetch+Execute)<=time(UncachedFetch+Execute)

According to yet another demonstrative embodiment, verifier 179 may utilize conditional branches, which may be derived, for example, from the secret value. A sequence of condition-changes and conditional branches may be formed, for example, in a way that generates an expected Fetch pattern on bus 135 during execution. When the secret value is unknown. e.g., during an attack, each condition has to be parsed and evaluated before emulating a next Fetch. It will be appreciated that evaluating a condition and performing a conditional branch may be faster than emulating the evaluation and the conditional branch, e.g., because the emulation itself requires another conditional branch during evaluation, as well as some costly parsing of instructions. According to this embodiment, gating code 165 may include conditional branches which may be based on the secret value.

According to this demonstrative embodiment, gating code 165 may include a sequence of conditional branch commands. Each conditional branch command, when executed by processor 102, may result, for example, in processor 102 evaluating a condition relating to one or more values derived from secret value 129, and selectively executing the branch command based on the condition. According to this embodiment, controller 137 may control WD 131 to measure a sequence of predefined time periods during which processor 102 is to perform a respective sequence of branching operations resulting from the conditional branch commands. During each one of the time periods, controller 137 may provide WD 131 with the WD-off command, e.g., only if processor 102 performs a corresponding one of the conditional branching operations, as described below.

Although the invention is not limited in this respect, gating code 165 may include the following exemplary conditional branch code:
xor rX,rX# initialize to zero
xor rY,rY# initialize to zero

label1:
add rX,2# arbitrary change derived from secret value
add rY,3# arbitrary change derived from secret value
cmp rX,rY# compare
je <label7># jump-equal—will fail due to the above condition

label2:
sub rY,2# arbitrary change derived from secret value
sub rX,1# arbitrary change derived from secret value
cmp rX,rY# compare.
je <label4># jump-equal—will succeed due to the above condition

label3:
add rX,7# won't be executed because of the successful je
xor rY,rY# won't be executed because of the successful je
cmp rX,rY# won't be executed because of the successful je
je <label2># won't be executed because of the successful je

label4:
add rX,8# arbitrary change derived from secret value
cmp rX,rY# compare
je <label6># jump-above—will succeed because rX>rY due to label2 result

label5:

. . . # not executed because of the successful ja

The above demonstrative branching code may result, for example, in processor 102 executing an expected sequence of branches resulting in branching to label1, label2, label4, and label6, while skipping one or more labels, e.g., label 3 and label 5. It will be appreciated that, if the secret value is not known, then the expected sequence of branches may be generated only by emulating the entire code, which is bound to take more time than executing it in-place, even if the emulator itself is fully-cached.

The conditional branching code may be generated using a software condition-compiler. Alternatively, verifier 179 may include a memory-mapped hardware condition-generator 195, which may appear to processor 102 as a page of memory. Every time the page is read from, it may generate a conditional block which, when executed, “falls-thru” or “jumps”, according to a bit of the secret value. Since verifier 179 maintains the secret value, verifier 179 may be able to predict whether the condition block will fall-thru or jump. Accordingly verifier 179 may expect bus-signals over bus 135 to behave according to the condition block, e.g., within a relatively short time after the conditional block has been read. Although the invention is not limited in this respect, initialization of verifier 179 during Boot may not be required. For example, verifier 179 may iteratively read bits of the secret value from the RNG to generator 195 and WD controller 137.

According to some demonstrative embodiments of the invention, memory watcher 111 may provide an interrupt command to processor 102, e.g., upon receiving a request from processor 102 to access secure memory 108. The interrupt may have an interrupt vector pointing to the entry-point of secure code 163, e.g., if interrupts are enabled. The vector may point to an empty handler, e.g., if interrupts are disabled.

According to some demonstrative embodiments of the invention, verifier 179 may ensure that interrupts to processor 102 are disabled during transition between the non-secure mode and the secure mode. For example, verifier 179 may trigger an interrupt to processor 102, e.g., substantially simultaneously to activating WD 131. The interrupt may include, for example, a highest priority interrupt, or all possible interrupts, e.g., if system 100 does not support interrupt prioritization. Alternatively, verifier 179 may mask all interrupts to processor 102, e.g., during a time period beginning substantially simultaneously to activating WD 131, and ending after executing a secure-handler code, as described below.

According to some demonstrative embodiments of the invention, WD controller 137 may cause WD 131 to pause the countdown, e.g., if processor 102 stalls in bus-wait, e.g., while another component of system 100 takes control over bus 135. WD controller 137 may cause WD 131 to resume the countdown, e.g., once processor 102 resumes control of bus 135.

Some demonstrative embodiments of the invention are described herein with reference to a computing system, e.g., system 100, including a verifier, e.g., verifier 179, to verify that a processor, e.g., processor 102, executes a gating code, e.g., gating code 175. However, it will be appreciated by those skilled in the art that the invention is not limited in this respect, and other embodiments of the invention may be applied a computing system, e.g., a SMP system, including a plurality of processors connected to a bus. For example, the system may include a plurality of watchdogs corresponding to the plurality of processors, respectively. The system may also include a memory watcher to identify a current processor controlling the bus. A watchdog corresponding to the current processor may be selectively activated, e.g., if the current processor attempts to access the secure memory.

According to some demonstrative embodiments of the invention, computing system 100 may also include an attack counter 147 to count a number of times validation output 169 is generated. Counter 147 may be implemented, for example, by a persistent counter, e.g., using a NVRAM or any other suitable persistent memory or storage. Violation output 147 may cause, for example, counter 147 to increase by a predefined number, e.g., one. Although the invention is not limited in this respect, access to secure memory 108, to secure code 163 may be disabled, the contents of secure memory 108 may be erased and/or any other suitable operation may be performed by any suitable component of system 100, e.g., if counter 147 reaches a predefined threshold value, which may indicate system 100 may be under attack.

According to some demonstrative embodiments of the invention, memory 108 may also include a secure-handler code 162, which when executed by processor 102, may result in a secure-mode handler. Handler code 162 may be maintained, for example, as part of secure code 163. The handler may execute a context-switch, e.g., after processor 102 performs the one or more gating operations, which may result in verifier 179 verifying that processor 102 executes gating code 165. It will be appreciated that interrupts to processor 102 may be disabled during the context-switch, since verifier 179 may disable interrupts to processor 102, e.g., as described above. The context-switch may ensure that no untrusted code may be invoked during operation in the secure mode. For example, the context switch may replace an interrupt vector table of processor 102 with a trusted table, which may point to one or more trusted handlers. Additionally, the context switch may replace and/or disable one or more exception-handlers and/or external events, which may alter the course of execution. In some embodiments, the context-switch may invalidate part or all of a cache of processor 102. In some embodiments, the context switch may verify part or all of an MMU table of processor 102, e.g., to ensure that MMU may not be used to divert secure virtual pages to insecure physical pages.

According to some demonstrative embodiments of the invention, the secure handler may optionally re-enable interrupts to processor 102, e.g., after completing the context switch. It will be appreciated that after completing the context switch it may be assumed that any suitable trusted code may be executed by processor 102, without worrying about security-breaches, as long as the secure mode is not terminated by the trusted code or a trusted interrupt-handler.

According to some demonstrative embodiments of the invention, gating code 165, and/or handler code 162 may be initialized during Boot. Although the invention is not limited in this respect, in one example, boot code 175, when executed by processor 102, may result in the following sequence of operations:
1. Generate secret value.
2. Initialize Secure-Memory (configure Memory Watcher).
3. Copy secure handler code to secure memory.
4. Replace at least a first instruction of the handler with code resulting in one or more gating operations (e.g., at least one direct-write (STORE) instruction to write the secret value to the verifier; one or more LOAD instructions to access one or more memory addresses; a branching table; and/or a conditional branching table)—overwrite at least one placeholder instruction of the same size, in a code location of the first instruction.
5. Set the secure-mode interupt's vector in the system's interrupt vector table (e.g., in insecure memory) to point to the handler.
6. Initialize the watchdog with the secret value.

According to some demonstrative embodiments of the invention, secure code 163 may result in a dispatcher, which may be able to read and “sanitize” parameters from a location in insecure memory and/or registers of processor 102. The dispatcher may call suitable, e.g., trusted, functions to perform a requested operation. The dispatcher may copy results of the operation to insecure memory, perform a transition back to the non-secure mode, e.g., while removing sensitive data from cache, registers, and any other storage outside secure memory 108. The dispatcher may then cause memory watcher 111 to leave secure mode, e.g., within a cycle, and return to untrusted code 164. For example, the dispatcher may indicate to verifier 179 that the secure mode is to be terminated, and verifier 179 may cause memory watcher 111, e.g., by disabling signal 146, to terminate the secure mode.

Optionally, the handler may call one or more plug-in functions from untrusted memory. A location, size, and/or cryptographic hash of a plug-in function may be stored in secure memory 108. Before calling the plug-in function, the handler may verify the cryptographic hash of the function. The verification may be performed every time secure-mode is re-entered and the plug-in is to be used, e.g., to disable untrusted code from injecting a hostile plug-in function into the secure mode. Alternatively, the plug-in function may be placed in a non-writable memory, e.g., memory 123, and cryptographic verification may not be necessary. An MMU table of processor 102 may be verified to ensure that virtual addresses of the MMU table correspond to the address of the plug-in in the non-writable memory.

According to some demonstrative embodiments of the invention, an untrusted caller running in the non-secure mode may invoke the secure mode, for example, by preparing a request block in memory 109, or one or more registers of processor 102. The request block may include, for example, a function number, parameters for the function, and/or a buffer to maintain results of the function. The request block may be generated, for example, analogously to invoking a system-call by a User Mode process. The caller may then trigger the secure mode, which may cause the dispatcher to take control over processor 102, e.g., while the caller is “put to sleep” and the dispatcher handles the request. The caller may “wake-up”, e.g., after the secure operation is performed in the secure mode, and results, if any, may be maintained in the buffer provided by the caller.

According to some demonstrative embodiments of the invention, system 100 may implement DMA. An attacker may trigger a DMA operation that accesses secure-memory 108, and immediately invoke the secure-mode.

According to some demonstrative embodiments of the invention, memory watcher 111 may prevent DMA access to secure-memory 108, and/or ensure that only processor 102 has access to secure-memory 108, e.g., even in secure-mode.

According to one demonstrative embodiment of the invention, memory watcher 111 may monitor an output of a bus-arbitrator (not shown) of bus 135, and disable access to secure memory 108, e.g., when processor is not the bus-master of bus 135.

According to another demonstrative embodiment of the invention, memory watcher 111 may selectively allow to perform direct-memory access to secure memory 108, based on signal 146. For example, memory watcher 111 may compare an address-bus output of a controller of address bus 135 to an address-bus input of secure memory 108. Memory watcher 111 may generate violation output 189 if, for example, the address-bus output does not match the address-bus input. For example, memory watcher 111 may be wired as a pass-through filter on, or in parallel to, an address-bus output of processor 102. Alternatively, memory watcher 111 may compare an address-bus output of a DMA controller to the memory's address-bus input

According to some demonstrative embodiments of the invention, secure code 163 may allocate a buffer in secure memory 108, e.g., in order to perform a secure-DMA operation. Secure code 163 may pass the buffer to a secure DMA controller, which may be accessible only when system 100 is in the secure mode. When performing the DMA operation, memory watcher 111 may identify that the current bus-master is the secure-DMA controller, and may allow the performing the DMA operation, e.g., regardless of the mode of operation. When the DMA operation has finished, the DMA controller may generate a DMA interrupt. The handler for the DMA interrupt may switch to secure-mode, and secure code 163 may handle the DMA data, e.g., without exposing the raw data back to the insecure-mode code. The secure-DMA controller may be useful, for example, in association with secure-mode hardware, e.g., the CryptoCell™ manufactured by Discretix Inc., USA. A DMA controller of the secure-mode hardware may only accept requests when system 100 is in the secure mode. Secure code 163 may provide the DMA controller with a buffer which is located in secure-memory 108, and the secure-mode hardware may perform one or more operations and write the results into the secure-memory buffer. Upon completion, the secure-mode hardware may generate an interrupt. The interrupt handler of the secure-mode hardware may invoke secure-mode, passing a parameter indicating that the secure-DMA operation has completed. Secure code 163 may then handle a result of the secure-DMA operation.

According to some demonstrative embodiments of the invention, system 100 may include a dual-use DMA controller 155, e.g., serving both secure-mode and insecure-mode. DMA controller 155 may receive an indication signal 114 indicating whether system 100 is operating in the secure mode. For example, signal 114 may include, or may be based on, signal 146. DMA controller 155 may maintain a value corresponding to signal 114, e.g., when DMA controller 155 is requested to perform a task over bus 135 (“the task request”). Accordingly, DMA controller 155 may maintain a value indicating whether or not the task request has been received during the secure mode. DMA controller 155 may provide memory watcher 111 with a signal 118 corresponding to the maintained value, e.g., when DMA controller 155 intends to access memory 108 according to the task request. Memory watcher 111 may determine whether the attempt to access memory 108, being performed by DMA controller 155, has been generated during the secure mode, e.g., based on signal 118. Memory watcher 111 may treat an access attempt to memory 108 in analogy to treating an access attempt to memory 108 when receiving signal 146, e.g., if signal 118 indicates that the task request has been generated during the secure mode. Memory watcher 111 may treat the access attempt to memory 108 in analogy to treating an access attempt to memory 108 when not receiving signal 146, e.g., if signal 118 indicates that the task request has not been generated during the secure mode. Accordingly, the secure mode may be extended to DMA operations, allowing DMA controller 155 to operate with both secure-mode code and insecure-mode code, e.g., without “leaking” data between the two modes.

According to some demonstrative embodiments of the invention, it may be desired to ensure that secure-mode is invoked periodically. For example, secure-mode may be used to verify the integrity of some data structures, and an attacker must not be able to prevent the invocation of secure-mode. According to some demonstrative embodiments of the invention, system 100 may also include a security WD 159 to be activated by a predefined trigger event, e.g., a clock event or a predefined interrupt. Security WD 159 may be turned-off, for example, upon receiving an indication, e.g., signal 146, that the system is in the secure mode. Security WD 159 may generate a violation output 157, e.g., if WD 159 is not turned-off within a predefined time period. This may assure that insecure-mode code must branch into secure-mode within a certain time-limit after the trigger event.

According to some demonstrative embodiments of the invention, it may be desired to have a certain interrupt attached to secure-mode, and trigger a branch to secure-mode entry point asynchronously. This may be useful, for example, when secure-mode runs a separate operating-system, which may be mandatory scheduled, e.g., regardless of the operations of the insecure-mode OS. As described above, security WD 159 may enforce secure-mode invocation, after a certain external event occurs, or periodically, e.g., if attached to a clock. Security WD 159 may not be able to force processor 102 to branch into Secure-Mode, e.g., since security WD 159 is external to processor 102. However, the non-secure code may include an interrupt handler to trigger a branch into secure-mode upon certain events, and security WD 159 may ensure that the branch occurs within a predefined time period after the triggering.

For example, insecure-mode OS may call secure-mode from an insecure-mode OS scheduler. Security watchdog 159 may be configured to count time from a predefined value, T, to zero, and generate violation output 157, e.g., if WD 157 reaches zero. Security WD 159 may be set back to countdown from the value T, e.g., when WD 159 receives an indication, e.g., signal 146, that system 100 is in the secure mode. It will be appreciated that during normal operation of system 100, WD 159 may not reach zero, e.g., since the insecure-mode OS scheduler may invoke secure-mode before WD 159 reaches zero. If, however, an attacker takes over the insecure-mode OS and prevents secure-mode invocation, watchdog 159 may generate violation 157, which may cause, for example, a reset of system 100.

Some demonstrative embodiments of the invention are described above with reference to a system, e.g., system 100, configured to operate in either one of a secure mode or a non-secure mode. However it will be appreciated that other embodiments of the invention may relate to a system able to operate in more than one secure mode, as described below.

According to some demonstrative embodiments of the invention, system 100 may have more than on secure-mode of operation. In one example, a single secure-mode may not guarantee full compartmentalization if, for example, system 100 is required to run two secure applications which may be mutually-distrusting. In another example, a plurality of secure modes may be required in a system that does not implement an MMU to enable compartmentalizing applications.

According to some demonstrative embodiments of the invention, at least one address range 113 may include a plurality of address ranges corresponding to a plurality of secure modes. For example, each secure mode may be related to one or more secure address ranges. Memory watcher 111 may maintain a plurality of ID values 116 associated with the plurality of secure modes, respectively. For example, ID value 116 may be associated with one or more of address ranges 113. Upon identifying an attempt to access secure memory 108, memory watcher 111 may raise a number of bits, representing an ID of IDs 116 (“the violation ID”) corresponding to an address range of ranges 113 including the requested address. Verifier 179 may maintain a table of secret values, addresses, or branching codes, e.g., instead of the single secret value, address, or branching code described above. WD controller 137 may turn-off WD 131, e.g., only if processor 102 executes gating code corresponding to the violation ID.

In one non-limiting example, memory watcher 111 may store a field of 4 bits, which may be used to identify up to 16 IDs 116 corresponding to up to 16 secure modes. Memory watcher 111 may be connected to verifier 179 with 4 lines. Verifier 179 may maintain a table of up to 16 random sequences, e.g., secret values, addresses and/or branching codes. This configuration may result in up to 16 independent verifiers, each to verify an entry-point of a respective secure mode code. The 16 secure modes may be symmetric, e.g., since no secure mode may have power over the others. An application can have its own secure-mode without trusting any other parts of the system, including other trusted applications.

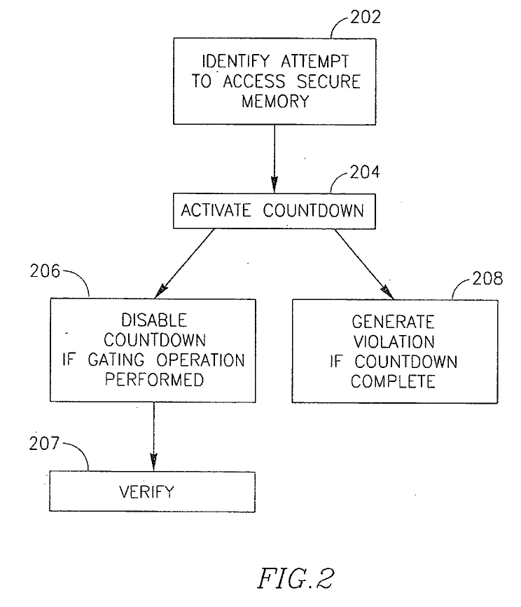

Reference is now made to FIG. 2, which schematically illustrates a method of verifying a gating code is executed by a processor according to one demonstrative embodiment of the invention. Although the invention is not limited in this respect, one or more operations of the method of FIG. 2 may be performed by computing system 100 (FIG. 1), processor 102 (FIG. 1), memory watcher 111 (FIG. 1), and/or verifier 179 (FIG. 1), for example, to verify that processor executes gating code 165 (FIG. 1).

According to some demonstrative embodiments of the invention, the gating code, when executed by the processor may result in the processor performing one or more gating operations. In one example, the gating operations may include writing a secret value to a verifier, for example, if the gating code includes an immediate/direct write command to write the secret code to the verifier, e.g., as described above. In another example, the gating operations may include accessing one or more memory addresses, for example, if the gating code includes one or more load commands, e.g., as described above. In yet another example, the gating operations may include branching between a sequence of memory addresses, for example, if the gating code includes branching code, e.g., as described above. In yet another example, the gating operations may include performing conditional branches between a sequence of memory addresses, for example, if the gating code includes conditional branching code, e.g., as described above.

As indicated at block 202, the method may include identifying an attempt to access secure memory. For example, memory watcher 111 (FIG. 1) may provide verifier 179 (FIG. 1) with signal 148 indicating an attempt to access secure code 163 (FIG. 1), e.g., as described above.

As indicated at block 204, the method may include activating a countdown of at least one predefined time period during which the processor is to perform the one or more gating operations. For example, verifier 179 (FIG. 1) may activate WD 131 (FIG. 1), e.g., upon receiving signal 146, to countdown the at least one predefined time period, e.g., as described above.

As indicated at block 208, the method may include generating a violation output if the processor does not perform the one or more gating operations within the predefined time period. For example, verifier 179 (FIG. 1) may generate violation output 169 (FIG. 1) if WD 131 (FIG. 1) completes the countdown.

As indicated at block 206, the method may include disabling the countdown if the processor performs the one or more gating operations. For example, WD controller 137 (FIG. 1) may provide WD 131 (FIG. 1) with the WD-off command, e.g., only if the secret value is written to verifier 179 (FIG. 1), the one or more addresses are accessed, the sequence of branching operations is performed, or the sequence of the conditional branches are performed, before WD 131 (FIG. 1) completes the countdown.

As indicated at block 207, the method may include verifying that the processor has executed the gating code. For example, verifier 179 (FIG. 1) may generate signal 146 (FIG. 1), e.g., only if the secret value is written to verifier 179 (FIG. 1), the one or more addresses are accessed, the sequence of branching operations is performed, or the sequence of the conditional branches are performed, before WD 131 (FIG. 1) completes the countdown.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus comprising:
a memory to store a secure code;
a processor intended to execute a gating code, wherein said gating code, when executed by said processor, results in said processor to perform at least one operation and set a program counter of said processor to point to an entry point of said secure code; and
a verifier to verify that said processor had executed said gating code only if said processor performs said at least one operation.

2. The apparatus of claim 1, wherein said verifier is able to generate a violation output if said processor does not perform said at least one operation during at least one predefined time period.

3. The apparatus of claim 2, wherein said verifier maintains at least one secret value;
wherein said gating code, when executed by said processor, results in said processor writing said at least one secret value to said verifier; and
wherein said verifier generates said violation output if said secret value is not written to said verifier during said predefined time period.

4. The apparatus of claim 2, wherein said predefined time period comprises a time period shorter than a time period required for said processor to perform a read operation followed by a write operation.

5. The apparatus of claim 3, wherein said at least one secret value comprises a sequence of secret values;
wherein said gating code, when executed by said processor, results in said processor writing said sequence of values to said verifier;
wherein said at least one predefined time period comprises a sequence of predefined time periods during which said secret values are to be written to said verifier, respectively; and
wherein said verifier generates a violation output when a secret value of said sequence of secret values is not written to said verifier during a respective time period of said sequence of time periods.

6. The apparatus of claim 2, wherein said verifier maintains at least one address value representing at least one respective memory address;
wherein said gating code, when executed by said processor, results in said processor accessing said at least one memory address; and
wherein said verifier is able to generate said violation output if said address is not accessed during said time period.

7. The apparatus of claim 6, wherein said time period comprises a time period substantially equal to a time period required for said processor to execute a load operation.

8. The apparatus of claim 6, wherein said at least one address value comprises a sequence of address values representing a sequence of memory addresses, respectively;
wherein said gating code, when executed by said processor, results in said processor accessing said sequence of addresses;
wherein said at least one predefined time period comprises a sequence of predefined time periods, during which said sequence of addresses are to be accessed, respectively; and
wherein said verifier generates said violation output when an address of said sequence of addresses is not accesses during a respective time period of said sequence of time periods.

9. The apparatus of claim 2, wherein said gating code comprises a sequence of branch commands stored in a sequence of addresses, respectively; and
wherein said sequence of branch commands, when executed by said processor, results in said processor sequentially branching between said addresses.

10. The apparatus of claim 9, wherein said at least one predefined time period comprises a sequence of predefined time periods, during which said processor is to sequentially branch between said sequence of addresses, respectively; and
wherein said verifier generates said violation output when an address of said sequence of addresses is not accessed during a respective time period of said sequence of time periods.

11. The apparatus of claim 2, wherein said gating code comprises a sequence of conditional branch commands; and wherein each conditional branch command, when executed by said processor, results in said processor evaluating a condition relating to one or more values derived from a secret value and in selectively executing said branch command based on said condition.

12. The apparatus of claim 11, wherein said at least one predefined time period comprises a sequence of predefined time periods, during which said processor is to perform a respective sequence of branching operations resulting from said conditional branch commands; and wherein said verifier generates said violation output when a branching operation of said sequence of branching operations is not performed during a respective time period of said sequence of time periods.

13. The apparatus of claim 12, wherein each of said sequence of time periods comprises a time period substantially equal to a time period required for said processor to execute an evaluation operation followed by a conditional branching operation.

14. The apparatus of claim 2, wherein said violation output causes said processor to reset.

15. The apparatus of claim 1 comprising a memory watcher to identify an attempt to access said secure code and, upon said attempt, to cause said verifier to verify whether said processor executes said gating code.

16. The apparatus of claim 15, wherein said verifier provides said memory watcher with a verification signal verifying that said processor executes said gating code.

17. The apparatus of claim 16, wherein said memory watcher selectively allows direct-memory-access to said secure code based on said verification signal.

18. The apparatus of claim 17, wherein said memory watcher compares an address-bus output of a controller of an address bus connecting said memory to said processor to an address-bus input of said memory, and generates a security violation output if said address-bus output does not match said address-bus input.

19. The apparatus of claim 16, wherein said memory watcher disables access to said memory when said processor does not control a bus connecting said processor and said memory.

20. The apparatus of claim 1, wherein said gating code is stored in said memory.

21. The apparatus of claim 1, wherein said verifier generates said gating code based on a secret value.

22. A method of verifying that a secure code is executed by a processor, said method comprising:
verifying that said processor executes a gating code,
wherein said gating code, when executed by said processor results in said processor to perform at least one operation prior to setting a program counter of said processor to point to an entry point of said secure code; and
wherein said verifying comprises verifying that said processor had executed said gating code only if said processor performs said at least one operation.

23. The method of claim 22 comprising generating a violation output if said processor does not perform said at least one operation during at least one predefined time period.

24. The method of claim 23, wherein said gating code, when executed by said processor, results in said processor writing said at least one secret value to a verifier, and wherein generating said violation output comprises generating said violation output if said secret value is not written to said verifier during said predefined time period.

25. The method of claim 23, wherein said predefined time period comprises a time period shorter than a time period required for said processor to perform a read operation followed by a write operation.

26. The method of claim 23 wherein said gating code, when executed by said processor, results in said processor accessing at least one memory address, and wherein generating said violation output comprises generating said violation output if said address is not accessed during said time period.

27. The method of claim 26, wherein said at least one address value comprises a sequence of address values representing a sequence of memory addresses, respectively;
wherein said gating code, when executed by said processor, results in said processor accessing said sequence of addresses;
wherein said at least one predefined time period comprises a sequence of predefined time periods, during which said sequence of addresses are to be accessed, respectively; and
wherein generating said violation comprises generating said violation output when an address of said sequence of addresses is not accesses during a respective time period of said sequence of time periods.

28. The method of claim 23, wherein said time period comprises a time period substantially equal to a time period required for said processor to execute a load operation.

29. The method of claim 23, wherein said gating code comprises a sequence of branch commands stored in a sequence of addresses, respectively; and wherein said sequence of branch commands, when executed by said processor, results in said processor sequentially branching between said addresses.

30. The method of claim 29, wherein said at least one predefined time period comprises a sequence of predefined time periods, during which said processor is to sequentially branch between said sequence of addresses, respectively; and generating said violation output comprises generating said violation output when an address of said sequence of addresses is not accessed during a respective time period of said sequence of time periods.

31. The method of claim 23, wherein said gating code comprises a sequence of conditional branch commands; and wherein each conditional branch command, when executed by said processor, results in said processor evaluating a condition relating to one or more values derived from a secret value and in selectively executing said branch command based on said condition.

32. The method of claim 31, wherein said at least one predefined time period comprises a sequence of predefined time periods, during which said processor is to perform a respective sequence of branching operations resulting from said conditional branch commands; and wherein said generating said violation output comprises generating said violation output when a branching operation of said sequence of branching operations is not performed during a respective time period of said sequence of time periods.

33. The method of claim 32, wherein each of said sequence of time periods comprises a time period substantially equal to a time period required for said processor to execute an evaluation operation followed by a conditional branching operation.

34. The method of claim 23, wherein generating said violation output comprises causing said processor to reset.

35. The method of claim 22 comprising identifying an attempt to access said secure code, wherein said verifying comprises verifying that said processor executes said gating code upon said attempt.

36. The method of claim 22 comprising generating a verification signal verifying that said processor executes said gating code.

37. The method of claim 36 comprising selectively allowing direct-memory-access to said secure code based on said verification signal.
